(19) United States
(12) Patent Application Publication
(10) Pub. No.: US 2026/0359740 A1
(43) Pub. Date: Nov. 12, 2026

(54) GENERATING A REPORT IDENTIFYING MODIFICATIONS TO TASKS HAVING ATTRIBUTES SATISFYING ONE OR MORE CRITERIA IDENTIFIED BY A USER THROUGH A GENERATIVE MODEL

(71) Applicant: Mango Technologies, Inc. DBA ClickUp, San Diego, CA (US)

(72) Inventors: Erich Elendt, Toronto (CA); Elliot Pourmand, Berkeley, CA (US); Hari Rajagopalan, Mountain View, CA (US)

(21) Appl. No.: 19/202,870

(22) Filed: May 8, 2025

(51) Int. Cl. G06Q 10/0631

(52) U.S. Cl. CPC G06Q 10/0631

(57) ABSTRACT

A task management system maintains tasks for performance by associated performing users. Each task has a set of attributes, and a performing user modifies a value of an attribute when working on a task. To review or to monitor performance of one or more tasks, the task management system generates a summary report in response to a request from a requesting user. In response to receiving the request, the task management system identifies a set of tasks having attributes with values matching specific values in the request and ranks the set of tasks based on task-specific relevance scores. Attributes of a task and activity data describing interaction with the task determine the relevance score for the task. Applying a generative model to a prompt including tasks ranked by their relevance scores generates the summary report, which includes descriptions of tasks based on their attributes.

### BACKGROUND

In many collaborative environments, such as product development, multiple users perform actions to complete a project. Often, different users perform different actions, with the completed actions of different users being combined to create the product. To monitor the progress of various actions performed by different users, a user may generate a task stored in a computer system. A task corresponds to an action and assigns a performing user to perform the task. Performing users interact with a task to modify one or more attributes of the task. Modifications to one or more attributes of the task because of the interaction provide information about performance of the task.

However, as a user is associated with an increasing number of tasks, determining current statuses for different tasks increases an amount of interaction by the user with one or more computing systems related to the tasks. For example, as a number of tasks associated with the user increases, the user transmits an increasing number of requests to a computing system to determine information about different tasks, increasing use of computing resources to identify and provide information about different tasks or increasing an amount of network bandwidth used to exchange data between a client device of the user and the computing device to accommodate the increased number of requests from the user's client device and an increased amount of data corresponding to different tasks transmitted from the computing device to the user's client device.

### SUMMARY

In accordance with one or more aspects of the disclosure, a task management system receives tasks from users. Each task identifies an action to be performed and includes a performing user assigned to perform the action. Further, each task is associated with one or more attributes that provide information about the task. In various embodiments, the task management system stores a task log in a data store to identify received tasks. In various embodiments, the task log includes multiple entries, with each entry corresponding to a task. An entry in the task log includes a task identifier of a task, a performing user assigned to perform the task, and one or more attributes of the task. Additionally, an entry in the task log corresponding to a task includes multiple attributes of the task. Example attributes of a task include: an identifier of a performing user assigned to perform the task, a status of the task, a due date for the task, a priority level of the task, a resource allocation (e.g., a budget) for performing the task, one or more comments about the task, or other information relevant to performing an action corresponding to the task.

The task management system stores a task log in a data store identifying received tasks. In various embodiments, the task log stores tasks in a hierarchical structure. For example, the task log includes one or more lists, with each list including one or more tasks. A user identifies a list including a task created by the user in various embodiments. In some embodiments, each task in a list is associated with a common identifier for the list. Further, in some embodiments, tasks in a list have a common value for at least one attribute. For example, a list includes multiple tasks that each have a common performing user. As another example, a list includes multiple tasks each having an attribute identifying a common entity (e.g., a common organization, a common department, etc.). The task log includes a list identifier and associates task identifiers of tasks in the list with the list identifier in various embodiments.

When performing an action corresponding to a task, a performing user performs one or more interactions with a task. In various embodiments, an interaction with a task modifies a value of one or more attributes of the task or generates an additional attribute and corresponding value for the task. For example, an interaction with task changes the status of task from “in progress” to “closed.” As another example, an interaction with task generates an additional comment stored in the task log in association with task. Hence, interactions with a task provide information about progress on performance of an action corresponding to the task.

As a performing user performs an action corresponding to a task, the performing user performs one or more interactions with the task that modify one or more attributes of the task. For example, an interaction with a task modifies a value of one or more attributes of the task or generates an additional attribute for the task. In an example, an interaction with the task changes a value of a status of the task or includes a comment for the task. Hence, interactions with a task provide information about progress on performance of an action corresponding to the task.

As performing users perform interactions with tasks, the task management system generates an interaction log comprising entries that each correspond to an interaction with a task by a user. In various embodiments, the interaction log includes multiple entries that each store an identifier of an interaction, a user who performed the interaction, a task identifier of a task on which the interaction was performed, a time when the interaction was performed, and a description of the interaction. Different information describing an interaction with a task may be included in an entry in the interaction log.

To monitor performance of actions for different tasks, a requesting user transmits a request to generate a summary report to the task management system. The summary report includes identifiers of various tasks and a description associated with each task. The description for a task is based on one or more attributes of the task. For example, the description for a task identifies values of one or more attributes or identifies a modification to a value of an attribute. The description may be based on a combination of attributes of a task in various embodiments. In conventional task management systems, a requesting user manually identifies specific tasks or groups of tasks having specific values for one or more attributes and manually reviews the identified tasks to determine one or more attributes of the tasks. This increases an amount of interaction by the requesting user with the task management system, increasing computational resources used by the task management system from processing multiple requests for different tasks. Similarly, receiving multiple requests that identify various tasks increases an amount of network bandwidth used for exchanging the requests and tasks corresponding to the received requests between the task management system and a client device via the network.

The task management system leverages the task log to more efficiently generate a summary report for a requesting user. The summary report includes information identifying one or more tasks and a description associated with each task for presentation to the requesting user. In various embodiments, the task management system receives a request to generate a summary report identifying a list and including specific values for one or more attributes of one or more tasks. For example, the requesting user selects an interface element for generating a summary report in an interface displayed by a client device and identifies one or more attributes and specific values for the one or more attributes. In some embodiments, the requesting user identifies a list along with the specific values for the one or more attributes. However, in other embodiments the task management system identifies the list based on a user identifier of the requesting user. For example, the task management system identifies a list including one or more tasks associated with the requesting user or identifies a list associated with the requesting user by the task management system.

In some embodiments, the interface presented to the requesting user includes a form. The form includes one or more fields each corresponding to different attributes of a task, and the requesting user selects one or more fields via the form and specifies one or more specific values for each of the selected fields to identify specific values for each attribute corresponding to a selected field. Based on the selected fields and corresponding specific values, the task management system generates the request. In various embodiments, the form includes a set of specific values in association with one or more fields, so the user selects a specific value of the set for a selected field. Alternatively, the requesting user selects a field to select an attribute and manually enters a specific value for the selected attribute.

In response to receiving the request, the task management system identifies a list of tasks. For example, the task management system identifies the list based on an identifier of the requesting user from whom the request was received. Based on the one or more attributes and corresponding specific values included in the request, the online system selects a set of tasks from the list. The set includes tasks from a list having values for the attributes included in the request that match the specific values included in the request. The task management system also retrieves attributes and activity data associated with each task of the set maintained by the task management system.

The task management system captures data describing interaction with various tasks via the task management system and stores the captured data as activity data in association with each task in the task log in various embodiments. For example, activity data associated with a task includes an amount of time that one or more users viewed or interacted with the task through a task management application executing on a client device. In various embodiments, the task management application (e.g., a browser) captures data including a task identifier of a task presented by the task management application, a user identifier of a user accessing the task management application, and an amount of time the application presented the task. Alternatively or additionally, the task management application captures information describing one or more interactions by the user with the task via the task management application. The task management application transmits the captured data to the task management system, which stores the captured data as activity data associated with the task corresponding to the task identifier. In various embodiments, the task management system stores different captured data including user identifiers of different users in association with a task, maintaining discrete data describing activity by different users with the task. The task management system generates and stores activity data for a task based on captured data received from one or more client devices associated with the task.

Various types of activity data may be obtained and stored by the task management system in various embodiments. For example, the task management system aggregates amounts of time one or more client devices presented a task to one or more users via one or more client devices and stores the aggregated amount of time the task was presented as activity data for the task. In various embodiments, the aggregated amount of time is determined for a specific time interval (e.g., during a specific week, during a specific day, etc.). As another example, the task management system determines a number of unique users of the task management system who performed one or more specific interactions with the task (e.g., viewed the task, edited the task, changed an attribute of the task, etc.) via one or more client devices during a specific time interval based user identifiers included in activity data associated with the task. The activity data may include a set of interactions each associated with a unique number of users in some embodiments. Further, the task management system generates one or more metrics based on a combination of unique users who performed one or more particular actions or a combination of a number of different specific interactions with the task; for example, a metric comprises a sum of a number of unique users who viewed a task and who edited the task.

To account for variations in relevance of different tasks of the set to the requesting user, the task management system determines a relevance score for each task of the set and ranks the tasks by their corresponding relevance scores. A relevance score for a task of the set is based on values of attributes of the task of the set or activity data of the task of the set. To determine a relevance score for the task, the task management system applies a weight corresponding to each attribute to a value of each attribute or a weight corresponding to each type of activity data to a corresponding value for each type of activity data and combines the weighted values. For example, the relevance score for a task is a weighted sum of values of attributes of the task and values of types of activity data for the task. As another example, the relevance score for a task is a weighted sum of values of attributes of the task, while in another example the relevance score for a task is a weighted sum or values of different types of activity data for the task. In various embodiments, a higher weight for an attribute of the task or a for type of activity data indicates the attribute or the type of activity data provides a greater indication of relevance of the requesting user. For example, an attribute of an entity has a maximum weight relative to other weights, so a common entity associated with the task and with the requesting user maximally affects the relevance score of the task.

Based on the relevance score for each task of the set, the task management system ranks the tasks of the set. When ranking the tasks of the set, tasks with higher relevance scores have higher positions in the ranking. The task management system uses the ranking of the tasks of the set to generate a prompt. The prompt includes each task of the set in the order specified by the ranking. In various embodiments, the prompt includes attributes of each task of the set in conjunction with the tasks. The prompt includes a subset of attributes in association with each task of the set in various embodiments, while in other embodiments the prompt includes each attribute associated with a task of the set. In various embodiments, the prompt includes text data identifying each task of the set and describing corresponding attributes and values of the attributes in association with each task of the set.

In some embodiments, the prompt also includes a formatting instruction. A generative model uses the formatting instruction to determine how to group tasks of the set and to display descriptions associated with tasks of the set to the requesting user. For example, a particular value for the formatting instruction causes generation of an output displaying a bulleted list identifying each task of the set with a description associated with each task of the set. As another example, a formatting instruction identifies one or more attributes of a task on which the generative model bases a description. In another example, a formatting instruction specifies an amount of detail included in a description of a task.

The requesting user selects the formatting instruction through one or more interface elements presented to the user when generating the request in various embodiments. For example, a form presented to the requesting user includes different interface elements, with each interface element corresponding to a different formatting instruction. In an example, the form displays three interface elements: an interface element for grouping tasks of the set based on one or more specific attributes, an additional interface element for displaying a summary of all modifications to attributes of tasks of the set, and an alternative interface element for displaying a general summary of modifications of attributes to tasks of the set. Different numbers of interface elements corresponding to different formats for presenting the tasks of the set may be presented to the user in various embodiments to provide the requesting user with options for presenting descriptions of tasks of the set.

The formatting instruction may be an example appended to the tasks of the set and associated attributes in the prompt by the requesting user in various embodiments. The example includes example tasks with associated attributes and an example format for presenting the example tasks and corresponding descriptions of the example tasks. In some embodiments, the task management system receives a selection of a formatting instruction from a set of formatting instructions displayed to the user, retrieves an example corresponding to the selected formatting instruction, and includes the retrieved example in the prompt. In various embodiments, the task management system receives a selection of multiple formatting instructions from the set of formatting instructions, retrieves an example corresponding to each selected formatting instruction, and includes the retrieved formatting instructions in the prompt. This allows the requesting user to leverage one or more formatting configurations maintained by the task management system. Alternatively, the requesting user may manually specify the formatting instruction. For example, the requesting user includes a user-generated example including example tasks and descriptions and an example report displaying the example tasks and descriptions to further customize how the generative model generates an output identifying tasks of the set and descriptions of tasks of the set.

A generative model receives the prompt, which comprises text, and generates text content based on the prompt. In various embodiments, the generative model is a large language model (LLM), such as a generative pre-trained transformer (GPT) model. The generative model is pre-trained to output text in response to a text prompt from a user through application to a text corpus prior to being stored by the task management system. Pre-training allows the generative model to learn relationships between text through application to a text corpus. The generative model subsequently leverages the learned relationships to generate the summary report based on the prompt. Hence, based on the prompt, the generative model generates the summary report identifying each task of the set and a description in association with each task of the set. A description associated with a task of the set is based on one or more attributes the task of the set in various embodiments.

The generative model generates the summary report based on the prompt. For example, the summary report identifies each task of the set and a description associated with each task of the set. In various embodiments, the summary report displays an identifier of each task of the set and a description associated with each task of the set based on one or more attributes of a task. For example, a description of a task identifies one or more attributes of the task and corresponding values of the one or more attributes. As another example, a description of a task identifies one or more modifications to one or more attributes of the task. The task management system transmits the summary report to a client device of the requesting user for presentation.

The task management system simplifies generation of the summary report by leveraging a hierarchical storage of tasks into various lists to identify a list based on a request and to select a set of tasks from the list having values of attributes matching specific values of attributes included in a request. This reduces an amount of time for the task management system to retrieve tasks for the summary report. Additionally, leveraging the hierarchical storage of tasks by the task management system to select the set of tasks reduces amount of user interaction with the task management system to generate the summary report. The task management system further leverages stored attributes of tasks and activity data associated with tasks to rank the set of tasks, which is used to order the set of tasks in a prompt to a generative model. This provides the generative model with an ordering of the tasks of the set based on relevance to the requesting user. The generative model uses the ordering of the tasks to determine how to sequence tasks and associated descriptions in a summary report to reduce interaction with the summary report for the requesting user to identify or to review different tasks. Ranking tasks based on attributes and activity data allows the task management system to use different attributes or activity data of tasks as a proxy for the likely relevance of a task to a user requesting the summary report for reduces an amount of interaction with the summary report for the requesting user to identify information about various tasks.

### BRIEF DESCRIPTION OF THE DRAWINGS

FIG. 1 illustrates an example system environment for a task management system, in accordance with one or more embodiments.

FIG. 2 illustrates an example system architecture for a task management system, in accordance with one or more embodiments.

FIG. 3 illustrates a flowchart of a method for generating a summary report describing attributes of one or more tasks satisfying one or more criteria, in accordance with one or more embodiments.

FIG. 4 illustrates a process flow diagram of a method for generating a summary report describing attributes of one or more tasks satisfying one or more criteria, in accordance with one or more embodiments.

### DETAILED DESCRIPTION

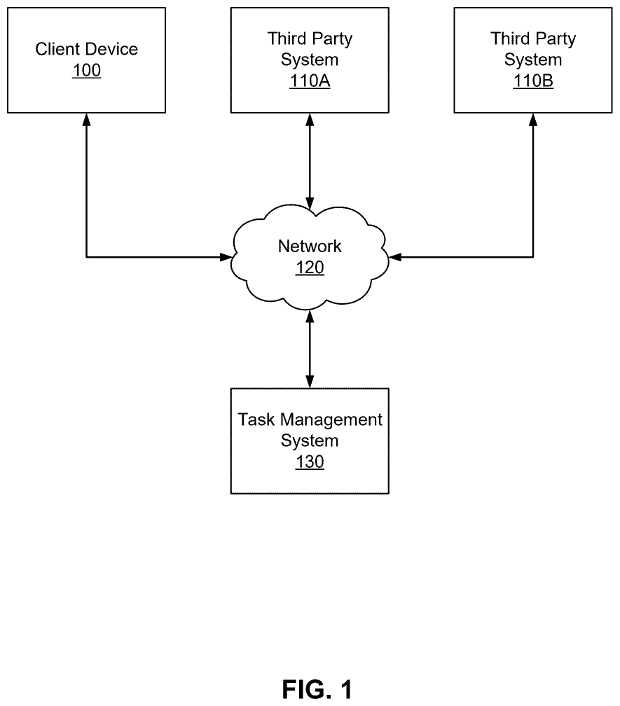

FIG. 1 illustrates an example system environment for a task management system 130, in accordance with one or more embodiments. The system environment illustrated in FIG. 1 includes a client device 100, one or more third party systems 110A, 110B (also referred to individually and collectively using reference number 110), a network 120, and a task management system 130. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

While FIG. 1 shows a single client device 100 for purposes of illustration, any number of client devices 100 may be included in the system environment. As such, there may be more than one client device 100 in various embodiments. The client device 100 is a device through which a user may interact with one or more third party systems 110 or with the task management system 130. The client device 100 can be a personal or mobile computing device, such as a smartphone, a tablet, a laptop computer, or desktop computer. In some embodiments, the client device 100 executes a task management application that uses an application programming interface (API) to communicate with the task management system 130.

Through interaction with the client device 100, a user creates one or more tasks stored by the task management system 130 via the task management application, with each task corresponding to one or more actions to be performed and a performing user to perform the one or more actions. The performing user may be the user who created the task or may be a different user. Additionally, the user may specify one or more attributes of a task. Example attributes of a task include a status of the task, a due date for the task, a priority level of the task, a resource allocation (e.g., a budget) for performing the task, one or more comments about the task, or other information relevant to performing an action corresponding to the task.

In various embodiments, the task management application executing on the client device 100 presents a workflow management interface to the user. The workflow management interface is a user interface that receives input from the user to identify or create tasks, generate a list of related tasks, generate a hierarchy of tasks, associate a task with a performing user, modify one or more attributes of a task, or perform other interactions affecting one or more tasks. In various embodiments, the workflow management interface allows the user to search for tasks satisfying one or more attributes that are identified by task management system 130 and accessible to the user. Additionally, the workflow management interface includes one or more messaging elements allowing the user to provide messages for transmission to one or more receiving users of the task management system 130.

The client device 100 may receive additional content from the task management system 130 to present to a customer. For example, the client device 100 may receive one or more messages for presentation to the user. As another example, the client device receives notifications from the task management system 130 and presents the notifications to the customer. A notification may indicate a change to an attribute of a task associated with the user (e.g., a change in a status of the task).

In some embodiments, the task management application also generates and presents a communication interface to the user that allows the customer to communicate messages to the task management system 130, to a receiving user of the task management system 130, or to a third party system 110. A message may include text data, audio data, image data, video data, or any combination thereof. For example, a message is a text message or a chat message. The client device 100 transmits a message via the network 120 and may receive one or more message via the network 120. In some embodiments, the communication interface may allow the user of the client device 100 and another user to communicate through audio or video communications, such as a phone call, a voice-over-Internet-Protocol call, or a video call.

A third party system 110 is a computing system separate from the task management system 130 that interacts with the task management system 130 or with the client device 100. In various embodiments, different third party systems 110A, 110B provide different types of content to the task management system 130 or to the client device 100. For example, a third party system 110 is an application provider communicating information describing one or more applications for execution by a client device 100 or communicating data to a client device 100 for use by an application executing on the client device 100. In other embodiments, a third party system 110 provides content or other information for presentation via a client device 100. A third party system 110 may also communicate information to the task management system 130, such as files, documents, metadata, or other information to the task management system 130.

The client device 100, the one or more third party systems 110, and the task management system 130 can communicate with each other via the network 120. The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as MPLS lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include BLUETOOTH® or near-field communication (NFC) technologies or protocols for local communications between computing devices. The network 120 may transmit encrypted or unencrypted data.

The task management system 130 is an online system by which users identify tasks specifying actions to be performed, identify a performing user to perform an action identified by a task, and specify attributes of the task. The task management system 130 maintains associations between users and tasks. For example, the task management system 130 stores an association between a task identifier of a task and one or more user identifiers of users, such as a user who identified the task and one or more performing users associated with the task. The task management system 130 receives modifications to one or more attributes of a task from a user associated with the task, and updates the attributes of the task based on the received modifications. Additionally or alternatively, the task management system 130 may modify one or more attributes of a task based on information describing actions performed by a user. The task management system 130 transmits a notification to a client device 100 of a user associated with a task in response to an attribute of the task being modified, allowing a user associated with the task to remain informed of changes to one or more attributes of the task.

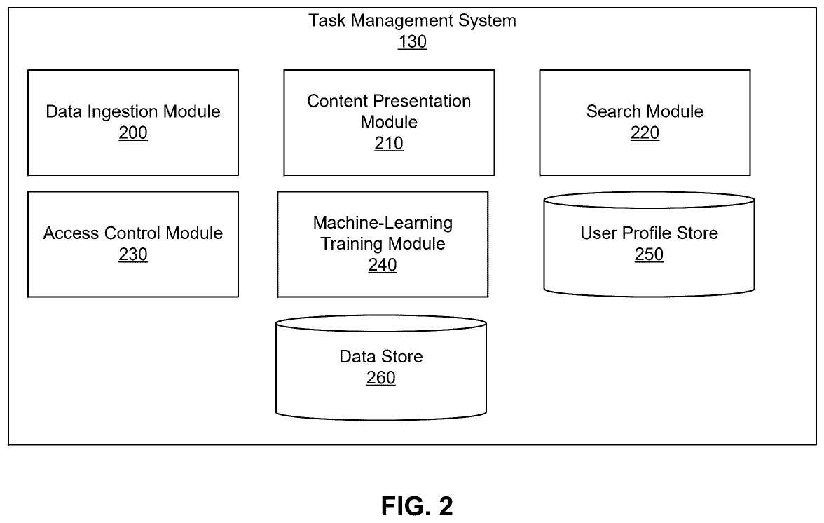

Additionally, the task management system 130 may generate one or more interfaces for a user associated with one or more tasks. For example, an interface identifies tasks associated with a user and identifies at least a set of attributes of the tasks, allowing the user to readily review and identify attributes of different tasks. The interface may identify relationships between tasks or between tasks and one or more sub-tasks of a task identified by a user, allowing a user to visualize relationships between different tasks. Further, the task management system 130 may store files or other data associated with a task or store information from retrieving files or data associated with the task from a third party system 110 to simplify access to data for reviewing or for performing a task for a user. The task management system 130 is described in further detail in conjunction with FIG. 2.

FIG. 2 illustrates an example system architecture for a task management system 130, in accordance with some embodiments. The system architecture illustrated in FIG. 2 includes a data ingestion module 200, a content presentation module 210, a search module 220, an access control module 230, a machine learning training module 240, a user profile store 250, and a data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data ingestion module 200 collects data used by the task management system 130 and stores the data in the user profile store. For example, the data ingestion module 200 receives information from a user creating a task, including one or more attributes of a task, or instructions for modifying one or more attributes of a task. Additionally, the data ingestion module 200 receives information from a user including characteristics of a user for inclusion in a corresponding user profile. The data ingestion module 200 may encrypt some or all of the obtained data, such as certain data describing a user.

The data ingestion module 200 also receives data describing relationships between tasks. For example, a user may identify one or more discrete sub-tasks that correspond to different portions of a task. Further, the data ingestion module 200 may receive data describing a hierarchy of tasks. For example, the data ingestion module 200 receives an identifier of a list from a user along with identifiers of one or more tasks to associate with the list. Hence, the list includes one or more tasks, allowing a user to organize related tasks, tasks related to a common objective, or tasks having one or more other common criteria. Additionally hierarchical information may be specified in some embodiments. For example, the data ingestion module 200 receives an identifier of a category and identifiers of one or more lists associated with the category, allowing a user to generate a grouping of lists, and the tasks included in the lists. As further described below, the data ingestion module 200 stores information describing relationships between tasks in the data store 260.

Additionally, the data ingestion module 200 captures interactions by users with tasks and stores the interactions in an interaction log included in the data store 260. In various embodiments, when a user interacts with a task through the task management system 130, the data ingestion module 200 determines an identifier of the user, an identifier of the task with which the user interacted, a time when the interaction occurred, and a description of the interaction by the user with the task. When the interaction with a task modifies an attribute of the task, the description of the interaction by the user includes an identifier of the attribute of the modifier of the task and a modified value of the task. In some embodiments, the description of the interaction includes an indication that the interaction changed at least one attribute of the task. Capturing interactions by users with tasks allows the data ingestion module 200 to generate an interaction log in the data store 260 that may be used to subsequently identify modifications to attributes of a task or a history of how one or more users interacted with a task. This may be leveraged to generate a record of how one or more users interacted with one or more tasks over time.

The content presentation module 210 selects content for presentation to a user and generates one or more interfaces for displaying the content to the user. In various embodiments, the content presentation module 210 receives a request for content from the user including one or more criteria, selects one or more tasks having characteristics satisfying one or more of the criteria, and generates an interface displaying information about the selected one or more tasks to a user. The content presentation module 210 generates instructions for transmission to a client device 100, which executes the instructions to generate an interface presenting the information about the selected one or more tasks. In various embodiments, the request from the user includes display instructions specifying how an interface presents information about the selected one or more tasks. For example, a request specifies a calendar view, so the content presentation module 210 generates an interface displaying information about one or more tasks on a calendar, with the calendar displaying information identifying a task, and one or more characteristics of the task, in a portion of the calendar corresponding to a date associated with the task. As another example, a request includes a specific attribute of a task, and the content presentation module 210 selects tasks having the specific attribute and generates instructions for an interface presenting the selected tasks.

In various embodiments, the content presentation module 210 receives a request from a user to generate a report via a client device 100. The request includes one or more criteria for content included in the report and a format for displaying content in the report. The content presentation module 210 retrieves a set of tasks (or other data objects) accessible to the task management system 130 having attributes that satisfy at least a threshold amount of criteria included in the request. For example, the request includes attributes and specific values for the attributes, and the content presentation module 210 selects a set of tasks having values for at least a threshold number of the attributes included in the request satisfying the corresponding specific values included in the request. To generate the report, the content presentation module 210 generates instructions that include the selected set of tasks and instructions for displaying the set of tasks included in the report. The content presentation module 210 transmits the instructions for the report to the client device 100, which executes the instructions to generate the report.

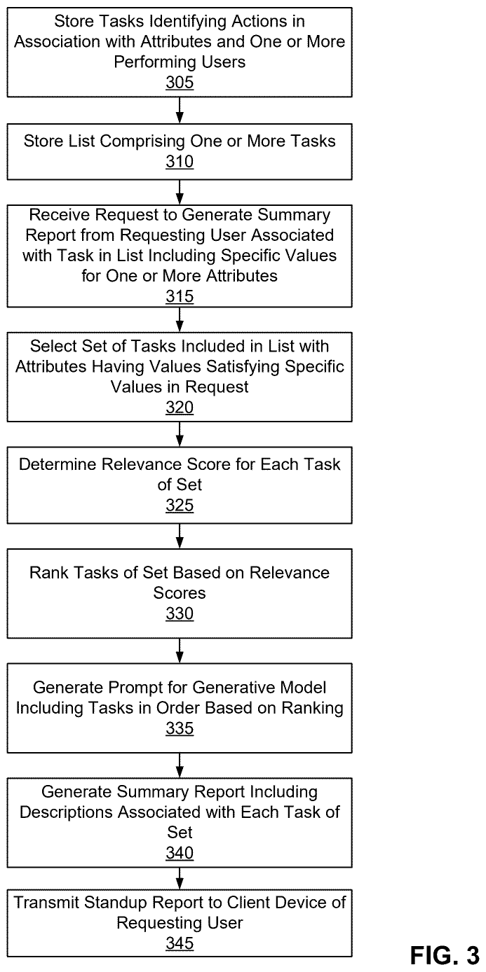

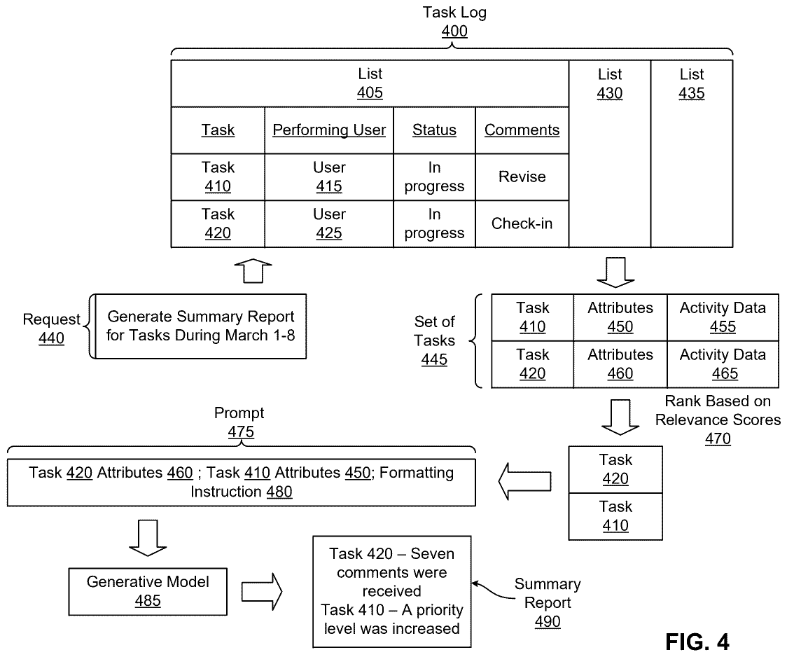

For example, the content presentation module 210 receives a request to generate a summary report from a user. The request includes information for identifying a list including one or more tasks as well as attributes and specific values corresponding to the attributes. In some embodiments, the request also includes a formatting instructions for the summary report. As further described below in conjunction with FIGS. 3 and 4, the content presentation module 210 selects a set of tasks included in the list that have at least a threshold number of attributes having values satisfying corresponding specific values included in the request. For each task of the set, the content presentation module 210 determines a relevance score based on attributes of a task and activity data describing activity by users with the task, as further described below in conjunction with FIG. 3. Based on the relevance scores, the content presentation module 210 ranks the tasks of the set and generates a prompt for input to a generative model that generates the summary report from the prompt. As further described below in conjunction with FIGS. 3 and 4, the prompt includes tasks of the set, as well as attributes of the tasks, in an order based on the ranking. Based on the prompt with the ordered tasks of the set, the generative model generates a summary report that identifies each task of the set and a description of each task of the set, with a description of a task based on one or more attributes of the task. A formatting instruction included in the prompt specifies how the summary report identifies different tasks and information included in the description of a task in various embodiments. The content presentation module transmits instructions for generating the summary report to a client device 100, which executes the instructions to present the summary report.

The search module 220 receives a search query from the client device 100 and retrieves search results comprising tasks, or other data object, with attributes at least partially satisfying the search query. Data objects may be documents, video files, audio files, or other files accessible to the search module 220. A search query is text for a word or set of words that indicate attributes of a task or another data object. In various embodiments, the search module 220 generates a score for each task, or other data object, at least partially satisfying the search query and presents the search results based on their corresponding scores. For example, the search module 220 scores tasks or other data objects based on a measure of relevance of a task or a data object to a search query. For example, the search module 220 applies natural language processing (NLP) techniques to text in the search query to generate a search query embedding representing characteristics of the search query. The search module 220 may use the search query embedding to score candidate items for presentation to a customer (e.g., by comparing a search query embedding to an item embedding).

In some embodiments, a user authorizes the task management system 130 to access information associated with the user and stored by a third party system 110. In various embodiments, the search module 220 stores authentication information for the third party system 110 corresponding to the user in association with an identifier of the user and an identifier of the third party system 110. The authentication information for the third party system 110 may be a combination of a username and password or other authentication information for the user to access the third party system 110. In various embodiments, when the task management system 130 receives a search query from the user, the task management system, through one or more application programming interfaces (APIs), the search module 220 transmits the search query to the third party system 110 and retrieves files or other content items from the third party system 110 that at least partially satisfy the search query. This allows the search module 220 to evaluate both locally stored data in the data store 260 and data maintained by a third party system 110 for the user for search results, allowing the search module 220 to provide search results accounting for data associated with the user from one or more third party systems 110 that the user authorized the task management system 130 to access.

The access control module 230 regulates access to tasks by various users. When a user accesses the task management system 130, the access control module 230 retrieves a user profile of the user from the user profile store 250. Based on one or more permissions in the user profile, the access control module 230 identifies a subset of tasks from the data store 260 for the user based on the one or more permissions. For example, the access control module 230 identifies a subset of tasks that one or more permissions of the user authorize the user to access. Tasks in the subset may be presented to the user or be otherwise accessible to the user, while tasks in the data store 260 and not in the subset are inaccessible to the user. Hence, the access control module 230 to regulate access to stored tasks for different users,

Similarly, for a task, the access control module 230 determines a set of interactions a user is authorized to perform with the task based on one or more permissions in the user profile of the user. For example, a user with a first type of permission is authorized to modify one or more attributes of a task, while another user with a different type of permission is authorized to view the attributes of the task but is unable to modify one or more attributes of the task. As another example, one or more permissions of the user authorize the user to modify a set of attributes of the task, while preventing the user from modifying attributes that are not included in the set. The access control module 230 may receive permissions or modifications to permissions of a user from the user or from another user and store the permissions or the modified permissions in a user profile corresponding to the user. This allows the access control module 230 to regulate types of interactions with a task based on permissions of a user, enabling different users to perform different types of interactions with different tasks.

The machine learning training module 240 trains machine learning models used by the task management system 130. The task management system 130 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 240 generates the set of parameters for a machine learning model by “training” the machine learning model. Once trained, the machine learning model uses the set of parameters to transform inputs into outputs.

The machine learning training module 240 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 240 may apply an iterative process to train a machine learning model whereby the machine learning training module 240 trains the machine learning model on each of the set of training examples. To train a machine learning model based on a training example, the machine learning training module 240 applies the machine learning model to the input data in the training example to generate an output. The machine learning training module 240 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 240 updates the set of parameters for the machine learning model based on the score generated by the loss function. For example, the machine learning training module 240 may apply gradient descent to update the set of parameters.

In various embodiments, the machine learning training module 240 tunes one or more generative models that receive a text prompt and generate content based on the text prompt. A generative model is a large language model (LLM), such as a generative pre-trained transformer model (GPT) in various embodiments. The generative model may generate text in response to a text prompt in various embodiments. Alternatively or additionally, the generative model selects or generates an image in response to a text prompt. A generative model is model pre-trained on a text corpus including text to output text in response to a text prompt from a user. As another example, a generative model is a generative image model pre-rained on a corpus of images to output an image in response to a received text prompt. Obtaining a pre-trained generative model allows the machine learning training module 240 to leverage relationships between different text (or images) the generative model learned through application to a text corpus or image corpus including a larger amount of data and more varied data than the task management system 130 maintains.

In various embodiments, the machine learning training module 240 generates examples for inclusion in a prompt input to a generative model. An example includes an input to the generative model and an expected output in response to the input. For example, an example includes input text and output text along with formatting instructions for the output text. When applying a generative model to input, the task management system 130 (e.g., the content presentation module 210) generates a prompt for the generative model that includes the input and one or more examples generated by the machine learning training module 240. This allows the example included in the prompt to specify a format or content of the output of the generative model based on the input. In some embodiments, the machine learning training module 240 generates a GPT index including embeddings corresponding to example to facilitate identification and retrieval of one or more supplemental examples based on an embedding of an input to a generative model. The machine learning training module 240 stores the GPT index including the supplemental examples, or the embeddings for the supplemental examples in various embodiments.

The user profile store 250 includes a user profile corresponding to each user of the task management system 130. A user profile of a user includes a user identifier of a corresponding user, characteristics of the user, contact information for the user, or other descriptive information about the user. In various embodiments, the user profile of the user includes task identifiers of tasks associated with the user. Further, in some embodiments, the user profile of the user includes one or more permissions of the user. One or more permissions included in the user profile of a user identify types of interactions the user is permitted to perform with one or more tasks. Different permissions may correspond to different tasks, allowing the user to perform different types of interactions with different tasks. A user profile may also maintain references to interactions by the corresponding user performed on one or more tasks and stored in an interaction log in the data store 260. This allows the user to review or to identify one or more interactions the user previously performed with tasks.

The data store 260 stores data used by the task management system 130. For example, the data store 260 stores tasks created by a user. In various embodiments, the data store 260 includes a task log that includes a task identifier for each task with corresponding attributes of a task associated with the task identifier. For example, the task log includes a task identifier for a task with attributes of the task associated with the task identifier. As further described above, example attributes of the task include: an identifier of a user to perform the task, a status of the task, a due date for the task, a priority level of the task, a resource allocation (e.g., a budget) for performing the task, one or more comments about the task, or other information relevant to performing an action corresponding to the task.

Additionally, the data store 260 stores an interaction log describing interactions by users with the task management system 130. The interaction log includes entries including a task identifier, a user identifier of a user who performed an interaction, a time when the interaction was performed, and a description of the interaction. The description of the interaction may be a type of the interaction and may include data received through the interaction. For example, an interaction is a comment on a task, and a description of the interaction includes a type indicating a comment and text data comprising the comment. In various embodiments, the interaction log organizes entries chronologically, while in other embodiments, the interaction log may organize entries using other formats.

The data store 260 also stores trained machine learning models trained by the machine learning training module 240. For example, the data store 260 may store the set of parameters for a trained machine learning model on one or more non-transitory, computer-readable media. As another example, the data store 260 stores parameters comprising a previously trained model that the machine learning training module 240 obtained from a third party system 110 or from another source. For example, the data store 260 includes a generative model, such as a large language model (LLM) that the machine learning training module 240 obtained from a third party system 110. The data store 260 may also include one or more examples that a machine learning model, such as a generative model receives as input. The data store 260 uses computer-readable media to store data, and may use databases to organize the stored data.

FIG. 3 illustrates a flowchart of a method for generating a summary report identifying attributes of one or more tasks satisfying one or more criteria, in accordance with some embodiments. Alternative embodiments may include more, fewer, or different steps from those illustrated in FIG. 3, and the steps may be performed in a different order from that illustrated in FIG. 3. These steps may be performed by the task management system 130, or by another online system, in various embodiments. Additionally, each of these steps may be performed automatically by the task management system 130 without human intervention.

As further described above in conjunction with FIG. 2, the task management system 130 stores 305 tasks created by one or more users. A task identifies an action to be performed and is associated with one or more performing users assigned to perform the action. Additionally, a task has one or more attributes that are maintained by the task management system 130. Example attributes of a task include: the performing user assigned to the task, a status of the task, a due date for the task, a priority level of the task, a resource allocation (e.g., a budget) for performing the task, one or more comments about the task, or other information relevant to performing an action corresponding to the task.

Additionally, the task management system 130 generates and stores 310 a list including one or more tasks. A user identifies a list including a task created by the user in various embodiments, and the task management system 130 stores 310 the task in the list identified by the user. In some embodiments, each task in a list is associated with a common identifier for the list. Further, in some embodiments, tasks in a list have a common value for at least one attribute. For example, a list includes tasks that each have an attribute identifying a common performing user, so the list includes tasks assigned to the common performing user. As another example, a list includes tasks that each have an attribute identifying a common entity, such as a specific department or a specific organization. In another example, each task of the list includes an attribute identifying a common category. The task management system 130 stores 310 an identifier of the list and identifiers of each task included in the list to identify tasks included in different lists in various embodiments.

As a user may be a performing user associated with multiple tasks or may be interested in modifications to attributes of various tasks, identifying multiple tasks may be time-intensive for the user, as well as resource intensive for the task management system 130. For example, the user transmits multiple requests identifying individual tasks that the task management system 130 individually retrieves and transmits one or more attributes of each individual task to a client device 100 of the user, which increases computational resources used by the task management system 130 from receiving and processing multiple requests to retrieve multiple discrete tasks in response the multiple requests. Alternatively, for a user to determine values of one or more attributes of various tasks, the user transmits messages requesting information about individual tasks to performing users associated with different individual tasks. Subsequently, the performing users transmit information about one or more attributes of the different individual tasks to the user in response to the messages, increasing an amount of network bandwidth for transmitting the messages and the attributes of various tasks between a client device 100 of the user and the task management system 130 and between the task management system 130 and client devices 100 associated with different performing users.

To simplify a requesting user obtaining information about one or more attributes of one or more tasks included in a list, the task management system 130 receives 315 a request from the requesting user to generate a summary report. The request identifies one or more attributes and corresponding specific values. For example, the request identifies an attribute of a status and includes one or more specific status indicators for the status. As another example, the request identifies a time interval as an attribute and includes a specific duration for the time interval (e.g., a specific date, a specific duration relative to a time when the request was received 315, etc.). Specifying the specific duration identifies a range of times for modifications to attributes of the one or more tasks. As another example, the request identifies an attribute of a performing user and includes user identifiers of one or more performing users. The request includes multiple attributes with corresponding specific values in some embodiments, allowing the request to specify a combination of attributes and specific values.

In various embodiments, the task management system 130 transmits a form to a client device 100 of the requesting user in response to receiving a specific input from the requesting user to generate the request. The form includes one or more fields each corresponding to a different attribute of a task. The requesting user selects one or more fields via the form and specifies one or more specific values for each of the selected fields to identify specific values for attributes corresponding to the selected fields. Based on the selected fields and corresponding specific values, the task management system 130 generates the request. In various embodiments, the form includes a set of specific values in association with one or more fields, so the requesting user selects a specific value of the set when selecting a field. Alternatively, the requesting user manually enters a specific value for an attribute corresponding to a field selected by the requesting user.

In various embodiments, the request also includes a formatting instruction specifying a format in which the summary report presents descriptions associated with tasks. A description associated with a task in the summary report is based on one or more attributes of the task, as further described below. For example, the formatting instruction specifies a level of detail included in a description of a task. As another example, the formatting instruction includes criteria for grouping tasks in the summary report. In an example, the formatting instruction specifies one or more grouping attributes, so the summary report includes groups of tasks that each correspond to different values of a grouping attribute, with each task in a group having a common value for a grouping attribute corresponding to the group. As another example, the formatting instruction specifies one or more particular attributes to include in a description of a task in the summary report. The requesting user may select a formatting instruction from a predefined set of formatting instructions maintained by the task management system 130 and presented via an interface (e.g., via the form) or the requesting user manually specifies a formatting instruction in various embodiments.

Based on the received request, the task management system 130 selects 320 a set of tasks from a data store 260. When selecting 320 the set of tasks, the task management system 130 identifies a list including one or more tasks based on the request and selects 320 tasks included in the list and having attributes with values satisfying at least a threshold amount of the specific values for corresponding attributes included in the request as the set of tasks. Hence, the set of tasks comprises tasks included in a list based on the request having the one or more specific values for attributes included in the request.

In various embodiments, the request includes an identifier of a list and the task management system 130 selects 320 the set of tasks based on tasks included in the list corresponding to the identifier of the list in the request. Alternatively, the task management system 130 identifies a list based on the requesting user. For example, the task management system 130 identifies one or more tasks for which the requesting user is a performing user and identifies a list including an identified task having the requesting user as the performing user. The task management system 130 may use additional characteristics of a user when identifying a list based on tasks having the requesting user as the performing user in some embodiments. In other embodiments, the request includes a task identifier of a task and the task management system 130 identifies a list including the task, then selects 320 the set of tasks as tasks from the identified list.

As further described above in conjunction with FIG. 2, the data store 260 includes an interaction log having entries for each interaction performed through the task management system 130 with a task by users of the task management system 130. Hence, each entry in the interaction log corresponds to an interaction with a task by a user, with each entry including an identifier of an interaction, a task identifier of a task with which the interaction was preformed, a user identifier of a user who performed an interaction, a time when the interaction was performed, and a description of the interaction. An attribute in the request may be a type of interaction in various embodiments, so the task management system 130 selects 320 one or more tasks included in the list associated with the specific type of interaction in various embodiments.

While the set of tasks includes tasks from the identified list with attributes having one or more specific values included in the request, different tasks have different levels of relevance to the requesting user. To account for differing levels of relevance of different tasks of the set to the requesting user, the task management system 130 determines 325 a relevance score to the requesting user of each task of the set. Based on the relevance scores, the task management system 130 ranks 330 the tasks of the set. Hence, the relevance score for a task of the set provides a measure of relevance of the task to the requesting user.

To determine 325 a relevance score of a task of the set, the task management system 130 obtains activity data associated with the task of the set from the data store 260. In various embodiments, the task management system 130 receives data describing activity by one or more users with various tasks captured by a task management application associated with the task management system 130. The task management system 130 stores the captured data in association with the corresponding task in the data store 260. For example, activity data associated with a task includes an amount of time that one or more users viewed or interacted with the task through the task management application executing on a client device 100. In various embodiments, the task management application comprises a bowser, while in other embodiments the task management application comprises a specific application executing on a client device 100 and associated with the task management system 130. The task management application captures data including a task identifier of a task presented by the task management application, a user identifier of a user accessing the task management application, and an amount of time the task management application presented the task (or an amount of time the user performed one or more specific interactions with the task). As another example, the task management application captures information describing interactions with a task presented by the task management application and a user identifier of the user and a task identifier of the task. The task management application transmits the captured data to the task management system 130, which stores the captured data in association with the task corresponding to the task identifier. In various embodiments, the task management system 130 stores different captured data including user identifiers of different users in association with a task, maintaining discrete data describing activity by different users with the task. The task management system 130 generates activity data for a task based on captured data received from one or more client devices 100 associated with the task. The activity data provides information about activity involving the task by one or more users, allowing the task management system 130 to determine and to maintain various metrics describing how users interact with various tasks.

Different types of activity data may be maintained in various embodiments. For example, the task management system 130 aggregates amounts of time one or more client devices 100 presented a task to one or more users by various client devices 100 and stores the aggregated amount of time the task was presented as activity data for the task. In various embodiments, the aggregated amount of time is determined for a specific time interval (e.g., during a specific week, during a specific day, etc.). As another example, the task management system 130 determines a number of unique users of the task management system 130 who performed one or more specific interactions with the task (e.g., viewed the task, edited the task, changed an attribute of the task, etc.) via one or more client devices 100 during a specific time interval based on user identifiers included in activity data associated with the task as activity data for the task. The activity data may identify each of a set of interactions and a unique number of users who performed an interaction with the task associated with an interaction as activity data in some embodiments. Further, the task management system 130 generates one or more metrics based on combinations of unique users who performed one or more particular interactions with a task; for example, a metric comprises a sum of a number of unique users who viewed a task and a number of unique users who edited the task.

In addition to activity data associated with a task, the task management system 130 retrieves at least a group of attributes of the task. Example attributes in the group include: a date when the task was created, a date when the task was most recently edited, a number of other tasks connected to the task, an entity associated with the task, or a category associated with the task. However, different or additional attributes may be included in the group in various embodiments. Based on a combination of the activity data for a task and the set of attributes retrieved for the task, the task management system 130 determines 325 the relevance score for the task.

In some embodiments, the task management system 130 maintains weights corresponding to each attribute of the group or corresponding to different types of activity data. The task management system 130 applies a corresponding weight to a value of each attribute of the group or to a value of each type of activity data for the task and determines 325 the relevance score for the task as a combination of the weighted values. In various embodiments, the task management system 130 determines 325 the relevance score of the task of the set as a sum of a value of each attribute of the group multiplied by a corresponding weight and a value of each type of activity data multiplied by a corresponding weight. Other combinations of weighted values for each of the group of attributes and weighted values for types of activity data may be used to determine 325 the relevance score in other embodiments. In various embodiments, a higher weight corresponding to an attribute or to a type of activity data indicates the attribute or the type of activity data provides a greater indication of the task's relevance the requesting user. For example, an attribute of an entity associated with the task has a maximum weight, so a value based on whether an entity associated with the task matching entity associated with the user has a maximum effect on the relevance score. As another, types of activity data comprising amounts of times viewing or editing a task by users or comprising a metric based a combination of amounts of times viewing the task by users and amounts of time editing the task by users have higher weights than other types of activity data or than attributes of the group.

The task management system 130 may apply a trained generative model to the attributes of the group and to types of activity data tasks to determine weights for different attributes or for different types of activity data. As further described above in conjunction with FIG. 2, the generative model is pre-trained on a large text corpus before being obtained by the task management system 130. For example, the generative model is a large language model (LLM), such as a generative pre-trained transformer (GPT) language model. The generative model learned relationships between different portions of text during pre-training and leverages the learned relationships to generate output text in response to a received text prompt. The task management system 130 generates a ranking prompt for the generative model identifying each attribute of the group or each type of activity data and includes a request to select a subset of attributes or a subset of types of activity data based on relevance to the requesting user to rank the subset of attributes or the activity data based on the relevance to the requesting user. The generative model outputs a ranking of attributes of tasks or types of activity data received in the ranking prompt. Based on the ranking of attributes, the task management system 130 determines weights for attributes or for types of activity data, with attributes or types of activity data having higher positions in the ranking having larger weights. Subsequently, the task management system 130 applies the determined weights for different attributes to values of the corresponding attributes or to values of the corresponding types of activity data for a task to determine 335 the relevance score for the task.

Based on the relevance scores, the task management system 130 ranks 330 the tasks of the set. In various embodiments, tasks with higher relevance scores have higher positions in the ranking, so a task of the set with a maximum relevance score has a highest position in the ranking, while a task of the set with a minimum relevance score has a lowest position in the ranking. Based on the ranking, the online concierge system 140 generates 335 a prompt for a generative model. The prompt includes an instruction to generate the summary report and the tasks of the set in an order specified by the ranking 330. Additionally, the prompt includes one or more attributes of each task in the prompt. For example, the prompt includes an identifier of a task of the set and each interaction by the performing user with the task of the set during the specific time interval, then includes an identifier of an additional task of the set and each of the group of attributes of a task and corresponding values in association with a task. Hence, the prompt includes tasks of the set ordered based on the ranking and corresponding attributes and values of attributes of the tasks set.

Ordering tasks of the set based on the ranking 330 in the prompt indicates a relative importance of different tasks of the set to the requesting user. Without ordering the tasks of the set in the prompt based on their relevance scores, the generative model is unable to accurately order descriptions for different tasks in an output to reduce an amount of time for the requesting user to review the summary report. Many generative models inaccurately reorder received inputs when summarizing received input, so ordering the tasks in the prompt based on the ranking 330 allows the generative model to leverage the ordering of the tasks in the prompt to order tasks in the summary report, reducing an amount of subsequent interaction by the requesting user with the summary report to review various tasks selected 320 for the set.

The task management system 130 includes a formatting instruction in the prompt in various embodiments. The formatting instruction describes a format for presenting information about tasks of the set in the summary report. For example, the task management system 130 appends the formatting instruction to the ordered tasks of the set. The formatting instruction is obtained from the request for the summary report in some embodiments, while in other embodiments, the formatting instruction is specified by the task management system 130. For example, the user selects a specific formatting instruction from a set of formatting instructions maintained by the task management system 130 for inclusion in the request. In some embodiments, the task management system 130 appends an example corresponding to the formatting instruction to the prompt to the tasks of the set in the prompt. The example includes example tasks and an example summary report for the example tasks. In various embodiments, the example may be retrieved from the data store 260. Alternatively, the requesting user manually enters or otherwise provides the example to the task management system 130. Including an example corresponding to the formatting instruction provides the generative model with an indication of an expected format the generative model leverages for presenting tasks and descriptions of tasks in the summary report based on the example tasks and the example summary report corresponding to the formatting instruction.

The task management system 130 applies the generative model, such as a large language model (LLM), to the prompt, and the generative model generates 340 the summary report based on the tasks of the set and attributes of the tasks of the set included in the prompt. The summary report includes information identifying each task of the set and as well as a description for each task of the set. The description of a task of the set is based on one or more attributes the task of the set and corresponding values for the attributes. In some embodiments, the summary report includes groups of tasks and their descriptions, with each task of a group having a common value for an attribute corresponding to the group. However, the summary report may differently group tasks of the set in various embodiments.

The summary report generated 340 by the generative model displays a description of each task of the set, with a description of a task based on at least one attribute of the task. For example, the description of a task includes one or more attributes (e.g., a status, comments, etc.) associated with the task and values corresponding to the one or more attributes. Further, the summary report orders the tasks of the set and their corresponding descriptions based on the order determined by the ranking 330. For example, the summary report displays a task identifier of a task of the set and a description for the task based on one or more attributes of the task in conjunction with the task. Hence, the summary report organizes tasks of the set based on their relevance scores and presents a description of each task of the set based on one or more attributes of tasks of the set to simplify review of various tasks and attributes of the various tasks.

In some embodiments, the task management system 130 applies the generative model to one or more attributes and corresponding values of a task of the set to generate the description of the task included in the summary report. Example attributes of a task of the set include: comments associated with the task by one or more users, modifications to one or more attributes of the task by the one or more users, a priority level of the task, or other descriptive information about the task. The generative model generates a summary of the comments associated with a task or a summary of modifications to the one or more attributes for inclusion in the summary report. Generating the description of a task of set using the generative model further simplifies review of a task of the set by including more specific information in the description of the task to the requesting user while reducing an amount of data for the requesting user to review for a task via the summary report.

The task management system 130 transmits 345 the summary report to a client device 100 of the requesting user. Subsequently, the client device 100 displays, or otherwise presents, the summary report to the user. For example, a task management application executing on the client device 100 generates an interface presenting the summary report to the requesting user.

FIG. 4 is a process flow diagram of one embodiment of a method for generating a summary report describing attributes of one or more tasks satisfying one or more criteria. As further described above in conjunction with FIG. 1-3, the task management system 130 receives tasks from users. Each task identifies an action to be performed and includes one or more performing users assigned to perform the action. Further, each task is associated with one or more attributes providing information about the task, as further described above in conjunction with FIGS. 1-3.

The task management system 130 stores a task log 400 in a data store 260 identifying received tasks. In various embodiments, the task log 400 stores tasks in a hierarchical structure. For example, the task log 400 includes one or more lists, with each list including one or more tasks. For example, a list includes multiple tasks that each have a common performing user. As another example, a list includes multiple tasks each having an attribute identifying a common entity (e.g., a common organization, a common department, etc.). However, a list may include multiple tasks each having different attributes in various embodiments. The task log 400 includes a list identifier and associates task identifiers of tasks in the list with the list identifier in various embodiments.

In various embodiments, the task log 400 includes multiple entries, with each entry corresponding to a task. An entry in the task log 400 includes a task identifier of a task, a performing user assigned to perform the task (e.g., a user identifier of the performing user), and one or more attributes of the task. For purposes of illustration, the example task log shown in FIG. 4 maintains list 405 including task 410 and task 420. In the example of FIG. 4, user 415 is assigned to task 410, while user 425 is assigned to task 420. Additionally, the task log 400 shown in FIG. 4 includes attributes for task 410 comprising a status of “in progress” and a comment of “revise.” Similarly, the example of FIG. 4 shows task log 400 including attributes for task 420 of a status of “in progress” and a comment of “check-in.” However, in other embodiments, the task log 400 includes different or additional attributes of tasks than the examples shown in FIG. 4. Other example attributes of a task may include: an identifier of a user who created a task, a due date for the task, a priority level of the task, a resource allocation (e.g., a budget) for performing the task, an entity associated with the task, or other information relevant to an action corresponding to the task. For purposes of illustration, the example task log 400 in FIG. 4 also includes list 430 and list 435, with each of list 430 and list 435 including one or more tasks that are not shown in FIG. 4.

When performing an action corresponding to a task, a performing user performs one or more interactions with a task. In various embodiments, an interaction with a task modifies a value of one or more attributes of the task or generates an additional attribute and corresponding value for the task. For example, an interaction with task 410 changes the status of task 410 from “in progress” to “closed.” As another example, an interaction with task 410 generates an additional comment stored in the task log 400 in association with task 410. Hence, interactions with a task provide information about progress on performance of an action corresponding to the task.

As further described above in conjunction with FIG. 3, as users perform interactions with a task, the task management system 130 generates an interaction log comprising entries that each correspond to an interaction with a task by a performing user. In various embodiments, each entry in the interaction log stores an identifier of an interaction, a user identifier of user who performed the interaction, a task identifier of a task on which the interaction was performed, a time when the interaction was performed, and a description of the interaction. Different information describing an interaction with a task may be included in an entry in the interaction log.

To monitor performance of actions for different tasks, a requesting user transmits a request 440 to generate a summary report to the task management system 130. As further described above in conjunction with FIG. 3, the summary report identifies each of a set of tasks and includes a description for each of a set of tasks. The description for a task is based on one or more attributes of the task. For example, the description for a task identifies values of one or more attributes or identifies a modification to a value of an attribute. The description may be based on a combination of attributes of a task in various embodiments. In conventional task management systems 130, a requesting user manually identifies specific tasks or groups of tasks having specific values for one or more attributes and manually reviews the identified tasks to determine one or more attributes of the tasks. This increases an amount of interaction by the requesting user with the task management system 130, increasing computational resources used by the task management system 130 from processing multiple requests for different tasks. Similarly, receiving multiple requests that identify various tasks increases an amount of network bandwidth used for exchanging the requests and tasks corresponding to the received requests between the task management system 130 and a client device 100 via the network 120.

The task management system 130 leverages the task log 400 to more efficiently generate a summary report for a requesting user. The summary report includes information identifying one or more tasks and a description associated with each task for presentation to the requesting user. In various embodiments, the task management system 130 receives a request 440 to generate a summary report identifying a list and including specific values for one or more attributes of one or more tasks. For example, the requesting user selects an interface element for generating a summary report in an interface displayed by a client device 100 and identifies one or more attributes and specific values for the one or more attributes. In some embodiments, the requesting user identifies a list along with the specific values for the one or more attributes. However, in other embodiments the task management system 130 identifies the list based on a user identifier of the requesting user. For example, the task management system 130 identifies a list including one or more tasks associated with the requesting user or identifies a list associated with the requesting user by the task management system 130.

In some embodiments, the interface presented to the requesting user includes a form. The form includes one or more fields each corresponding to different attributes of a task, and the requesting user selects one or more fields via the form and specifies one or more specific values for each of the selected fields to identify specific values for each attribute corresponding to a selected field. Based on the selected fields and corresponding specific values, the task management system 130 generates the request. In various embodiments, the form includes a set of specific values in association with one or more fields, so the user selects a specific value of the set for a selected field. Alternatively, the requesting user selects a field to select an attribute and manually enters a specific value for the selected attribute. For purposes of illustration, FIG. 4 shows the request 440 identifying a specific time interval of March 1 through March 8, for purposes of illustration. The specific time interval in the request 440 specifies a starting date and an ending data for received modifications to one or more attributes of tasks, while in other embodiments the request 440 includes a specific value for an attribute included in the request 440.

In response to receiving the request 440, the task management system 130 identifies list 405 of tasks. For example, the task management system 130 identifies list 405 based on an identifier of the requesting user from whom the request 440 was received. Based the one or more attributes and corresponding specific values included in the request 440, the online system 140 selects a set 445 of tasks from list 405. The set 445 includes tasks from list 405 having values for the attributes included in the request 440 that match the specific values included in the request 440. In the example of FIG. 4, the task management system 130 selects task 410 and task 420 from list 405 in response to receiving request 440. For example, task 410 and task 420 each have one or more attributes modified during the specific time interval of March 1 to March 8 specified by the request 440.

The task management system 130 also retrieves attributes 450 and activity data 455 associated with task 410 from the task log 400 and attributes 460 and activity data 465 associated with task 420. As further described above in conjunction with FIG. 3, the task management system 130 captures data describing interaction with various tasks via the task management system 130 and stores the captured data as activity data in association with each task in the task log 400 in various embodiments. For example, activity data associated with a task includes an amount of time that one or more users viewed or interacted with the task through a task management application executing on a client device 100. In various embodiments, the task management application (e.g., a browser) captures data including a task identifier of a task presented by the task management application, a user identifier of a user accessing the task management application, and an amount of time the application presented the task. Alternatively or additionally, the task management application captures information describing one or more interactions by the user with the task via the task management application. The task management application transmits the captured data to the task management system 130, which stores the captured data as activity data associated with the task corresponding to the task identifier. In various embodiments, the task management system 130 stores different captured data including user identifiers of different users in association with a task, maintaining discrete data describing activity by different users with the task. The task management system 130 generates and stores activity data for a task based on captured data received from one or more client devices 100 associated with the task.

Various types of activity data may be obtained and stored by the task management system 130 in various embodiments. For example, the task management system 130 aggregates amounts of time one or more client devices 100 presented a task to one or more users via one or more client devices 100 and stores the aggregated amount of time the task was presented as activity data for the task. In various embodiments, the aggregated amount of time is determined for a specific time interval (e.g., during a specific week, during a specific day, etc.). As another example, the task management system 130 determines a number of unique users of the task management system 130 who performed one or more specific interactions with the task (e.g., viewed the task, edited the task, changed an attribute of the task, etc.) via one or more client devices 100 during a specific time interval based user identifiers included in activity data associated with the task. The activity data may include a set of interactions each associated with a unique number of users in some embodiments. Further, the task management system 130 generates one or more metrics based on a combination of unique users who performed one or more particular actions or a combination of a number of different specific interactions with the task; for example, a metric comprises a sum of a number of unique users who viewed a task and who edited the task.

To account for variations in relevance of different tasks of the set 445 to the requesting user, the task management system 130 determines a relevance score for each task of the set 445 and ranks 470 the tasks by their corresponding relevance scores. A relevance score for a task of the set 445 is based on values of attributes of the task of the set 445 or activity data of the task of the set 445. As further described above in conjunction with FIG. 3, the task management system 130 associates different weights with different attributes of a task or with different types of activity data of a task. To determine a relevance score for the task, the task management system 130 applies a weight corresponding to each attribute to a value of each attribute or a weight corresponding to each type of activity data to a corresponding value for each type of activity data and combines the weighted values. For example, the relevance score for a task is a weighted sum of values of attributes of the task and values of types of activity data for the task. As another example, the relevance score for a task is a weighted sum of values of attributes of the task, while in another example the relevance score for a task is a weighted sum or values of different types of activity data for the task. In various embodiments, a higher weight for an attribute of the task or a for type of activity data indicates the attribute or the type of activity data provides a greater indication of relevance of the requesting user. For example, an attribute of an entity has a maximum weight relative to other weights, so a common entity associated with the task and with the requesting user maximally affects the relevance score of the task.

In some embodiments, the task management system 130 applies a generative model to the attributes of tasks and to the activity data when determining weights for different attributes or types of activity data, as further described above in conjunction with FIG. 3. A ranking prompt provided to the generative model includes an identifier of the requesting user or one or more characteristics of the requesting user in some embodiments to tailor weights applied to attributes or to activity types to the requesting user. The generative model generates a ranking of attributes of tasks and types of activity data, and the task management system 130 determines weights applied to attributes or to types of activity data based on the ranking of attributes or types of activity data, with attributes or types of activity data having higher positions in the ranking having larger weights.

Based on the relevance score for each task of the set 445, the task management system 130 ranks 470 the tasks of the set 445. In the example of FIG. 4, task 420 has a higher relevance score than task 410. When ranking 470 the tasks of the set 445, tasks with higher relevance scores have higher positions in the ranking. The task management system 130 uses the ranking 470 of the tasks of the set 445 to generate a prompt 475. The prompt 475 includes each task of the set 445 in the order specified by the ranking 470. In various embodiments, the prompt 475 includes attributes of each task of the set 445 in conjunction with the tasks. In the example of FIG. 4, prompt 475 includes attributes 450 of task 410 and attributes 460 of task 420. The prompt 475 includes a subset of attributes in association with each task of the set 445 in various embodiments, while in other embodiments the prompt 475 includes each attribute associated with a task of the set 445. In various embodiments, the prompt 475 includes text data identifying each task of the set 445 and describing corresponding attributes and values of the attributes in association with each task of the set 445.

In the example of FIG. 4, the prompt 475 initially identifies task 420 and attributes 460 associated with task 420, as task 420 has a highest position in the ranking 470. Subsequently, the prompt 475 identifies task 410, which has a lower position in the ranking 470 than task 420, and attributes 450 associated with task 410. In various embodiments, the prompt 475 includes delimiter characters to differentiate between different tasks and their associated attributes.

In some embodiments, the prompt 475 also includes a formatting instruction 480. A generative model 485 uses the formatting instruction 480 to determine how to group tasks of the set 445 and to display descriptions associated with tasks of the set 445 to the requesting user. For example, a particular value for the formatting instruction 480 causes generation of an output displaying a bulleted list identifying each task of the set 445 with a description associated with each task of the set 445. As another example, a formatting instruction 480 identifies one or more attributes of a task on which the generative model 485 bases a description. In another example, a formatting instruction 480 specifies an amount of detail included in a description of a task.

The requesting user selects the formatting instruction 480 through one or more interface elements presented to the user when generating the request 440 in various embodiments. For example, a form presented to the requesting user includes different interface elements, with each interface element corresponding to a different formatting instruction. In an example, the form displays three interface elements: an interface element for grouping tasks of the set 445 based on one or more specific attributes, an additional interface element for displaying a summary of all modifications to attributes of tasks of the set 445, and an alternative interface element for displaying a general summary of modifications of attributes to tasks of the set 445. Different numbers of interface elements corresponding to different formats for presenting the tasks of the set 445 may be presented to the user in various embodiments to provide the requesting user with options for presenting descriptions of tasks of the set 445.

The formatting instruction 480 may be an example appended to the tasks of the set 445 and associated attributes in the prompt 475 by the requesting user in various embodiments. The example includes example tasks with associated attributes and an example format for presenting the example tasks and corresponding descriptions of the example tasks. In some embodiments, the task management system 130 receives a selection of a formatting instruction 480 from a set of formatting instructions displayed to the user, retrieves an example corresponding to the selected formatting instruction 480, and includes the retrieved example in the prompt 475. This allows the requesting user to leverage one or more formatting configurations maintained by the task management system 130. Alternatively, the requesting user may manually specify the formatting instruction 480. For example, the requesting user includes a user-generated example including example tasks and descriptions and an example report displaying the example tasks and descriptions to further customize how the generative model 485 generates an output identifying tasks of the set 445 and descriptions of tasks of the set 445.

As further described above in conjunction with FIGS. 2 and 3, a generative model 485 receives the prompt 475, which comprises text, and generates text content based on the prompt 475. In various embodiments, the generative model 485 is a large language model (LLM), such as a generative pre-trained transformer (GPT) model. The generative model 485 is pre-trained to output text in response to a text prompt from a user through application to a text corpus prior to being stored by the task management system 130. Pre-training allows the generative model 485 to learn relationships between text through application to a text corpus. The generative model subsequently leverages the learned relationships to generate the summary report 490 based on the prompt 475. Hence, based on the prompt 475, the generative model 485 generates the summary report 490 identifying each task of the set 445 and a description in association with each task of the set 445. A description associated with a task of the set 445 is based on one or more attributes the task of the set 445 in various embodiments.

The generative model 485 generates the summary report 490 based on the prompt 475. For example, the summary report 490 identifies each task of the set 445 and a description associated with each task of the set 445. In various embodiments, the summary report 490 displays an identifier of each task of the set 445 and a description associated with each task of the set 445 based on one or more attributes of a task. For example, a description of a task identifies one or more attributes of the task and corresponding values of the one or more attributes. As another example, a description of a task identifies one or more modifications to one or more attributes of the task. The task management system 130 transmits the summary report 490 to a client device 100 of the requesting user for presentation.

The task management system 130 simplifies generation of the summary report 490 by leveraging a hierarchical storage of tasks into various lists to identify a list based on a request and to select a set of tasks from the list having values of attributes matching specific values of attributes included in a request 440. This reduces an amount of time for the task management system 130 to retrieve tasks for the summary report 490. The task management system 130 further leverages stored attributes of tasks and activity data associated with tasks to rank the set of tasks, which is used to order the set of tasks in a prompt to a generative model. This provides the generative model with an ordering of the tasks of the set based on relevance to the requesting user. The generative model uses the ordering of the tasks to determine how to sequence tasks and associated descriptions in a summary report to reduce interaction with the summary report for the requesting user to identify or to review different tasks. Ranking tasks based on attributes and activity data allows the task management system 130 to use different attributes or activity data of tasks as a proxy for the likely relevance of a task to a user requesting the summary report for reduces an amount of interaction with the summary report for the requesting user to identify information about various tasks.

### ADDITIONAL CONSIDERATIONS

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a non-transitory computer readable medium, comprising:
storing, at the computer system, tasks identifying actions to be performed, each task associated with one or more performing users to perform an action and each task having one or more attributes;
storing a list of tasks, the list including one more tasks, by the computer system;
receiving, at the computer system, a request to generate a summary report from a client device of a requesting user, the request including specific values for one or more attributes of one or more tasks and identifying the list;
selecting a set of tasks included in the list and having attributes with values for one or more attributes satisfying at least a threshold amount of the specific values for corresponding attributes included in the request;
determining a relevance score for each task of the set of tasks, the relevance score for a task of the set based on values of attributes of the task of the set and weights corresponding to different attributes of the task of the set;
ranking the tasks of the set based on the relevance scores;
generating a prompt for a generative model to generate the summary report, the prompt including each task of the set in an order specified by the ranking;
generating the summary report for the requesting user, the summary report identifying tasks of the set in the order specified by the ranking and including a description in association with each task of the set, the description for the task of the set based on one or more attributes the task of the set; and
transmitting the summary report from the computing system to the client device of the requesting user for presentation.

2. The method of claim 1, wherein selecting the set of tasks included in the list and having attributes with values for the one or more attributes satisfying at least the threshold amount of the specific values for corresponding attributes included in the request comprises:
identifying the list based on an identifier of the list included in the request; and
selecting tasks included in the list having values for the one or more attributes satisfying at least the threshold amount of the specific values for corresponding attributes included in the request.

3. The method of claim 1, wherein selecting the set of tasks included in the list and having attributes with values for the one or more attributes satisfying at least the threshold amount of the specific values for corresponding attributes included in the request comprises:
identifying the list based on a user identifier of the requesting user received with the request; and
selecting tasks included in the list having values for the one or more attributes satisfying at least the threshold amount of the specific values for corresponding attributes included in the request.

4. The method of claim 3, wherein identifying the list based on the user identifier of the requesting user received with the request comprises:
identifying a list including a task associated with the requesting user.

5. The method of claim 1, wherein determining the relevance score for each task of the set of tasks, the relevance score for a task of the set based on values of attributes of the task of the set and weights corresponding to different attributes of the task of the set comprises:
or for each of a subset of attributes of the task of the set, applying a weight corresponding to an attribute of the task of the set to a value of the attribute of the task of the set; and
determining the relevance score for the task of the set as a combination of the weighted values of the subset of attributes of the task of the set.

6. The method of claim 5, wherein applying the weight corresponding to the attribute of the task of the set to the value of the attribute of the task of the set comprises:
applying the generative model to a prompt including a ranking instruction to rank attributes and including the attributes of the task, the generative model outputting a ranking of the attributes of the task;
determining the weight for the attribute based on a position of the attribute in the ranking of the attributes of the task; and
applying the weight for the attribute to the value of the attribute.

7. The method of claim 1, wherein determining the relevance score for each task of the set of tasks, the relevance score for a task of the set based on values of attributes of the task of the set and weights corresponding to different attributes of the task of the set comprises:
retrieving activity data associated with the task of the set by the computer system, the activity data describing activity by one or more users with various tasks via one or more client devices obtained by the computer system;
for each of a group of attributes of the task of the set, applying a weight corresponding to an attribute of the task of the set to a value of the attribute of the task of the set;
for each type of activity data associated with the task of the set, applying a corresponding weight to a value of a type of activity data; and
determining the relevance score for the task of the set as a combination of the weighted values of the group of attributes of the task of the set and the weighted values of the types of activity data.

8. The method of claim 7, wherein the type of activity data comprises and aggregated amount of time the task was presented to the one or more users via the one or more client devices.

9. The method of claim 7, wherein the type of activity data is selected from a group consisting of: a number of unique users of the computer system who performed one or more specific interactions with the task of the set via one or more client device, a number of unique users who performed a specific interaction with the task of the set via the one or more client devices, a based on a combination of unique users who performed one or more particular interactions with a task, and any combination thereof.

10. The method of claim 1, wherein the request includes a formatting instruction for the summary report.

11. The method of claim 10, wherein generating the prompt for the generative model comprises appending an example corresponding to the formatting instruction to the tasks of the set in the order specified by the ranking, the example including example tasks and an example summary report.

12. A computer program product comprising a non-transitory computer readable medium having instructions encoded thereon that, when executed by a processor, cause the processor to perform steps comprising:
storing, at a task management system, tasks identifying actions to be performed, each task associated with one or more performing users to perform an action and each task having one or more attributes;
storing a list of tasks, the list including one more tasks, by the task management system;
receiving, at the task management system, a request to generate a summary report from a client device of a requesting user, the request including specific values for one or more attributes of one or more tasks and identifying the list;
selecting a set of tasks included in the list and having attributes with values for one or more attributes satisfying at least a threshold amount of the specific values for corresponding attributes included in the request;
determining a relevance score for each task of the set of tasks, the relevance score for a task of the set based on values of attributes of the task of the set and weights corresponding to different attributes of the task of the set;
ranking the tasks of the set based on the relevance scores;
generating a prompt for a generative model to generate the summary report, the prompt including each task of the set in an order specified by the ranking;
generating the summary report for the requesting user, the summary report identifying tasks of the set in the order specified by the ranking and including a description in association with each task of the set, the description for the task of the set based on one or more attributes the task of the set; and
transmitting the summary report from the task management system to the client device of the requesting user for presentation.

13. The computer program product of claim 12, wherein selecting the set of tasks included in the list and having attributes with values for the one or more attributes satisfying at least the threshold amount of the specific values for corresponding attributes included in the request comprises:
identifying the list based on an identifier of the list included in the request; and
selecting tasks included in the list having values for the one or more attributes satisfying at least the threshold amount of the specific values for corresponding attributes included in the request.

14. The computer program product of claim 12, wherein selecting the set of tasks included in the list and having attributes with values for the one or more attributes satisfying at least the threshold amount of the specific values for corresponding attributes included in the request comprises:
identifying the list based on a user identifier of the requesting user received with the request; and
selecting tasks included in the list having values for the one or more attributes satisfying at least the threshold amount of the specific values for corresponding attributes included in the request.

15. The computer program product of claim 14, wherein identifying the list based on the user identifier of the requesting user received with the request comprises:
identifying a list including a task associated with the requesting user.

16. The computer program product of claim 12, wherein determining the relevance score for each task of the set of tasks, the relevance score for a task of the set based on values of attributes of the task of the set and weights corresponding to different attributes of the task of the set comprises:
or for each of a subset of attributes of the task of the set, applying a weight corresponding to an attribute of the task of the set to a value of the attribute of the task of the set; and
determining the relevance score for the task of the set as a combination of the weighted values of the subset of attributes of the task of the set.

17. The computer program product of claim 12, wherein determining the relevance score for each task of the set of tasks, the relevance score for a task of the set based on values of attributes of the task of the set and weights corresponding to different attributes of the task of the set comprises:
retrieving activity data associated with the task of the set by the computer system, the activity data describing activity by one or more users with various tasks via one or more client devices obtained by the task management system;
for each of a group of attributes of the task of the set, applying a weight corresponding to an attribute of the task of the set to a value of the attribute of the task of the set;
for each type of activity data associated with the task of the set, applying a corresponding weight to a value of a type of activity data; and
determining the relevance score for the task of the set as a combination of the weighted values of the group of attributes of the task of the set and the weighted values of the types of activity data.

18. The computer program product of claim 17, wherein the type of activity data is selected from a group consisting of: a number of unique users of the task management system who performed one or more specific interactions with the task of the set via one or more client devices, a number of unique users who performed a specific interaction with the task of the set via the one or more client devices, a based on a combination of unique users who performed one or more particular interactions with a task, and any combination thereof.

19. The computer program product of claim 12, wherein the request includes a formatting instruction for the summary report.

20. The computer program product of claim 19, wherein generating the prompt for the generative model comprises appending an example corresponding to the formatting instruction to the tasks of the set in the order specified by the ranking, the example including example tasks and an example summary report.
